(19) United States
(12) Patent Application Publication
(10) Pub. No.: US 2018/0237599 A1
(43) Pub. Date: Aug. 23, 2018

(54) CURABLE RESIN COMPOSITION, COMPOSITION FOR MOLDING, RESIN MOLDED ARTICLE, AND METHOD FOR PRODUCING RESIN MOLDED ARTICLE

(71) Applicant: HITACHI CHEMICAL COMPANY, LTD., Chiyoda-ku, Tokyo (JP)

(72) Inventors: Toshiaki SHIRASAKA, Chiyoda-ku, Tokyo (JP); Kosuke YOKOYAMA, Chiyoda-ku, Tokyo (JP); Kazumasa TAKEUCHI, Chiyoda-ku, Tokyo (JP); Bungo OCHIAI, Yonezawa-shi, Yamagata (JP); Kazuki CHIBA, Yonezawa-shi, Yamagata (JP); Tomonari KIRYU, Yonezawa-shi, Yamagata (JP)

(21) Appl. No.: 15/753,015

(22) PCT Filed: Aug. 12, 2016
(86) PCT No.: PCT/JP2016/073791

§ 371 Date: Feb. 15, 2018

(30) Foreign Application Priority Data
Aug. 17, 2015 (JP) 2015-160619
Dec. 10, 2015 (JP) 2015-241233
Apr. 20, 2016 (JP) 2016-084663

(51) Int. Cl. C08J 3/24; C08F 20/18; C08F 20/54; C08G 18/81; C08F 20/44

(52) U.S. Cl. CPC C08J 3/246; C08F 20/18; C08F 20/54; C08G 2280/00; C08F 20/44; C08F 2810/20; C08G 18/8125

(57) ABSTRACT

Disclosed is a curable resin composition that includes radical polymerizable monomers including a monofunctional radical polymerizable monomer, a linear or branched polymer containing a polyoxyalkylene chain, and a radical polymerization initiator.

### TECHNICAL FIELD

The present invention relates to a curable resin composition, a composition for molding, a resin molded article, and a method for producing a resin molded article.

### BACKGROUND ART

In connection with resin molded articles, there is a demand for a material having excellent mechanical characteristics such as hardness that does not easily allow deformation, and strength and flexibility that do not lead to breakage even if the material is deformed. One of the methods for increasing the strength of a resin molded article is a method of forming a three-dimensional crosslinked structure. However, even though hardness is increased when this method is applied, the molded article tends to become brittle and crack easily.

As a method of increasing strength and flexibility, for example, a method of dispersing an elastomer component that is easily deformable, such as an acrylic rubber, in the resin and thereby relieving stress is generally known. Furthermore, it is also known that when a high molecular weight component is added to the resin, the strength of the resin molded article may be increased. Regarding the mechanism for strength enhancement, entanglement of polymer chains has been proposed.

Recently, attention has been paid to the crosslinked structure of polymers, there has been proposed an approach to increase strength by reducing stress concentration at crosslinked sites at the time of deformation. For example, there has been proposed a molecular design in which by having crosslinked sites formed reversibly, stress concentration between crosslinking points is reduced, or a pseudo-crosslinked structure called a pulley effect is formed, which leads to the formation of crosslinking points that can freely move, and thereby stress concentration is reduced.

Meanwhile, regarding shape memory materials, metals, resins, ceramics, and the like are known. In general, shape memory properties are manifested based on the phase transformation caused by a change in the crystal structure or a change in the form of molecular motion. Many shape memory materials have characteristics such as excellent vibration-proofing characteristics, in addition to shape restoring characteristics. Heretofore, investigations have been mainly conducted on metals and resins as the shape memory materials.

A shape memory resin is a resin that, even if the resin is defaulted due to a force exerted thereto after molding processing, restores the original shape when heated to or above a certain temperature. Compared to a shape memory alloy, a shape memory resin is generally excellent from the viewpoint of being inexpensive, having a high shape change ratio, and being lightweight, easily processable, and colorable.

Shape memory resins are soft at high temperature and are easily deformed like rubber. Meanwhile, shape memory resins are hard at low temperature and are not easily deformed, as in the case of glass. Shape memory resins can be stretched by a small force at high temperature to a length that is several times the original length and can retain the deformed shape by being cooled. When the material is heated in this state under non-loaded conditions, the material restores the original shape. At a high temperature, the material restores its original shape only by eliminating the force. Therefore, the characteristics of absorption and storage of energy at high temperature can be utilized.

Principal shape memory resins include polynorbornene, trans-isoprene, styrene-butadiene copolymers, and polyurethane. For example, shape memory resins are described in relation to a norbornene-based resin in Patent Literature 5, a trans-isoprene-based resin in Patent Literature 6, a polyurethane-based resin in Patent Literature 7, and an acrylic resin in Patent Literature 8.

### CITATION LIST

### Patent Literature

Patent Literature 1: Japanese Unexamined Patent Publication No. S60-36558

Patent Literature 2: Japanese Unexamined Patent Publication No. 2016-8232

Patent Literature 3: Japanese Unexamined Patent Publication No. 2004-35853

Patent Literature 4: Japanese Patent No. 3475252

Patent Literature 5: Japanese Examined Patent Publication No. H5-72405

Patent Literature 6: Japanese Unexamined Patent Publication No. 2004-250182

Patent Literature 7: Japanese Unexamined Patent Publication No. 2004-300368

Patent Literature 8: Japanese Unexamined Patent Publication No. H7-292040

### SUMMARY OF INVENTION

### Technical Problem

An object of one aspect of the present invention is to provide a curable resin composition capable of forming a resin molded article that has high elongation at break and excellent shape restorability after being deformed under stress.

An object of another aspect of the present invention is to provide a resin molded article having shape memory properties, which exhibits excellent heating-induced shape restorability.

### Solution to Problem

An aspect of the present invention relates to a curable resin composition comprising a linear or branched polymer containing radical polymerizable monomers including a monofunctional radical polymerizable monomer, and a polyoxyalkylene chain; and a radical polymerization initiator.

This curable resin composition can form a resin molded article that has high elongation at break and excellent shape restorability after being deformed under stress.

Another aspect of the present invention relates to a resin molded article comprising a first polymer containing a radical polymerizable compound represented by Formula (I):

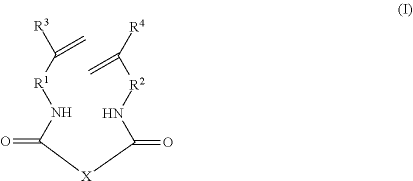

in which X, R¹, and R² each independently represent a divalent organic group; and R³ and R⁴ each represent a hydrogen atom or a methyl group, and a monofunctional radical polymerizable monomer, as monomer units; and a linear or branched second polymer.

This resin molded article may have a storage modulus of 0.5 MPa or higher at 25° C. Alternatively, the resin molded article may have shape memory properties. A relevant resin molded article has excellent heating-induced shape restorability.

Another aspect of the present invention relates to a composition for molding comprising radical polymerizable monomers (reactive monomers) including a radical polymerizable compound of Formula (I) and a monofunctional radical polymerizable monomer; and a second polymer. This composition for molding can form a resin molded article having a storage modulus of 0.5 MPa or higher at 25° C. when the radical polymerizable monomers are polymerized in the presence of the second polymer. Alternatively, this composition for molding can form a resin molded article having shape memory properties when the radical polymerizable monomers are polymerized in the presence of a second polymerizable monomer.

Another aspect of the present invention relates to a method for producing a resin molded article containing a first polymer and a second polymer. This method includes a step of producing a first polymer in a composition for molding that includes radical polymerizable monomers including a radical polymerizable compound of Formula (I) and a monofunctional radical polymerizable monomer, and a second polymer, the first polymer being produced by polymerization of the radical polymerizable monomers.

### Advantageous Effects of Invention

According to an aspect of the present invention, a curable resin composition that is capable of forming a resin molded article having high elongation at break and excellent shape restorability after being deformed under stress, is provided. A curable resin composition according to several embodiments can form a resin molded article having high strength, satisfactory toughness and transparency. Here, when it is said that a resin molded article has excellent shape restorability after being deformed under stress, it is implied that the resin molded article can easily restore the shape before receiving stress, only by being relieved from stress, and this does not necessarily mean that the resin molded article has shape memory properties of restoring the shape through heating.

Conventional ways of forming a crosslinked structure by utilizing dynamic bond formation or a pulley effect require complicated molecular designs, and also have a problem in view of cost and mass productivity. Formation of a pseudo-crosslinked structure utilizing the entanglement of main chains caused by addition of a high molecular weight component is convenient; however, in the current situation, the chance of obtaining sufficient effects is small. Furthermore, since a relatively large amount of a high molecular weight component is required, viscosity increase and deterioration of compatibility pose problems in many cases. According to the present invention, a curable resin composition that can relatively easily form a molded article having satisfactory mechanical characteristics compared to these conventional methods, can be provided.

According to another aspect of the present invention, a resin molded article having shape memory properties, the resin molded article having excellent heating-induced shape restorability. The rate of shape restoration when heated can be easily increased by controlling the elastic modulus of the resin molded article of the present invention. A resin molded article according to several embodiments is also excellent in view of various characteristics such as transparency, flexibility, stress relaxation characteristics, and water resistance.

### BRIEF DESCRIPTION OF DRAWINGS

FIG. 1 is a perspective view illustrating an embodiment of a resin molded article.

### DESCRIPTION OF EMBODIMENTS

Hereinafter, some embodiments of the present invention will be described in detail. However, the present invention is not intended to be limited to the following embodiments.

Curable Resin Composition

A curable resin composition according to an embodiment comprises radical polymerizable monomers including a monofunctional radical polymerizable monomer; a linear or branched polymer containing a polyoxyalkylene chain (hereinafter, may be referred to as “modifying polymer”); and a radical polymerization initiator. The modifying polymer usually does not have a radical polymerizable group and is incorporated into the curable resin composition as a component different from the radical polymerizable monomer.

A plurality of oxyalkylene groups that constitute the polyoxyalkylene chain in the modifying polymer may be identical with or different from each other. The polyoxyalkylene chain may be a random copolymer in which two or more kinds of oxyalkylene groups are irregularly arranged, or may be a block copolymer containing blocks in each of which the same oxyalkylene groups are successively linked. The polyoxyalkylene chain can be derived from, for example, a polyether such as a polyalkylene glycol.

The polyoxyalkylene chain in the modifying polymer may be a polyoxyethylene chain, a polyoxypropylene chain, a polyoxybutylene chain, or a combination thereof. Particularly, the polyoxyalkylene chain in the modifying polymer may be a polyoxyethylene chain, a polyoxypropylene chain, or a combination thereof.

The proportion of the polyoxyalkylene chain in the modifying polymer may be 20% to 60% by mass based on the mass of the modifying polymer. Thereby, an effect of enhancing the mechanical characteristics of the resin molded article according to the present invention is more noticeably provided.

A polyoxyethylene chain is easily entangled with the molecular chains of a polymer formed by polymerization of radical polymerizable monomers including a monofunctional radical polymerizable monomer, and has a slippery structure in which the portions where entanglement has occurred can easily move around. That is, it is contemplated that as polyoxyethylene chains are entangled with the molecular chains of other polymers, a pseudo-crosslinked structure in which entanglement points can slip and move freely is formed. When a pseudo-crosslinked structure is formed, the stress exerted at the various crosslinking points on an occasion in which the resin molded article is deformed is uniformly dispersed, and thereby strength and elongation of the resin molded article are increased.

The proportion of the polyoxyethylene chain may be 20% by mass or more, 30% by mass or more, or 40% by mass or more, based on the total mass of the polyoxyalkylene chains in the modifying polymer. When the proportion of the polyoxyethylene chain is high to a certain extent, the resin molded article obtained after curing can have especially excellent mechanical properties in view of strength, elongation, and the like. The proportion of polyoxyethylene chains may also be 70% by mass or less, 60% by mass or less, or 50% by mass or less, based on the total mass of the polyoxyalkylene chains in the modifying polymer. Thereby, crystallinity of the modifying polymer is suppressed. When crystallization is suppressed, the modifying polymer is likely to have high compatibility with other components and can have appropriately low viscosity.

The number average molecular weight of the polyoxyalkylene chains that constitute the modifying polymer is not particularly limited; however, the number average molecular weight may be, for example, 500 or more, 1,000 or more, or 3,000 or more. When the molecular weight of the polyoxyalkylene chains is large, formation of a pseudo-crosslinked structure tends to be promoted. The number average molecular weight of the polyoxyalkylene chains may also be 20,000 or less, 15,000 or less, or 10,000 or less. Thereby, the modifying polymer is likely to have high compatibility with other components and can have appropriately low viscosity. According to the present specification, unless particularly defined otherwise, the number average molecular weight and the weight average molecular weight mean values that are determined by gel permeation chromatography and are calculated relative to polystyrene standards.

The modifying polymer may contain two or more polyoxyalkylene chains and a linking group that connects those chains. A modifying polymer having a linking group contains, for example, a molecular chain represented by the following Formula (X). In Formula (X), R²¹ represents an oxyalkylene group; n¹¹, n¹², and n¹³ each independently represent an integer of 1 or greater; and L represents a linking group. A plurality of R²¹'s and L's in the same molecule may identical with or different from each other.

*R²¹ₙ_{¹¹}LR²¹ₙ_{¹²}LR²¹ₙ_{¹³}* (X)

The oxyalkylene group of R²¹ is represented by, for example, the following Formula (Y). In Formula (Y), R²² represents a hydrogen atom or an alkyl group having 4 or fewer carbon atoms; and n²⁰ represents an integer from 2 to 4. A plurality of R²²'s and n²⁰'s in the same molecule may be identical with or different from each other.

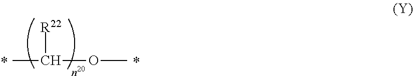

The linking group L in Formula (X) is a divalent organic group that connects two polyoxyalkylene chains. The linking group L may be an organic group containing a cyclic group, or a branched organic group. For example, the linking group may also be a divalent group represented by the following Formula (30).

*—Z⁵—R³⁰—Z⁶—* (30)

R³⁰ represents a cyclic group; a group containing two or more cyclic groups that are bonded to each other directly or via an alkylene group; or a branched organic group that contains carbon atoms and may contain a heteroatom selected from an oxygen atom, a nitrogen atom, a sulfur atom, and a silicon atom. Z⁵ and Z⁶ each represent a divalent group that links R³⁰ with a polyoxyalkylene chain, which is a linear chain, and examples thereof include groups represented by —NHC(═O)—, —NHC(═O)O—, —O—, —OC(═O)—, —S—, —SC(═O)—, —OC(═S)—, or —NR¹⁰— (wherein R¹⁰ represents a hydrogen atom or an alkyl group).

The cyclic group contained in the linking group L may contain a heteroatom selected from a nitrogen atom and a sulfur atom. The cyclic group contained in the linking group L can be an alicyclic group, a cyclic ether group, a cyclic amine group, a cyclic thioether group, a cyclic ester group, a cyclic amide group, a cyclic thioester group, an aromatic hydrocarbon group, a heteroaromatic hydrocarbon group, or combinations thereof. Specific examples of the cyclic group contained in the linking group L include a 1,4-cyclohexanediyl group, a 1,2-cyclohexanediyl group, a 1,3-cyclohexanediyl group, a 1,4-benzenediyl group, a 1,3-benzenediyl group, a 1,2-benzenediyl group, and a 3,4-furandiyl group.

Examples of the branched organic group contained in the linking group L (for example, R³⁰ in Formula (30)) include a lysinetriyl group, a methylsilanetriyl group, and a 1,3,5-cyclohexanetriyl group.

The linking group L represented by Formula (30) may be a group represented by the following Formula (31). R³¹ in Formula (31) represents a single bond or an alkylene group. R³¹ may also be an alkylene group having 1 to 3 carbon atoms. Z⁵ and Z⁶ have the same definitions as Z⁵ and Z⁶ of Formula (30), respectively.

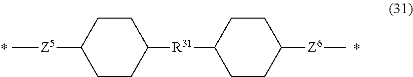

It is speculated that by introducing a sterically bulky cyclic structure or branched structure into the linking group L, when the resin molded article is deformed under stress, irreversible dissolution in the entanglement of molecular chains formed by the polyoxyalkylene chains does not easily occur. The inventors of the present invention considered that this contributes to a balance between high elongation of the resin molded article and the manifestation of shape restorability after deformation.

The weight average molecular weight of the modifying polymer is not particularly limited; however, for example, the weight average molecular weight may be 3,000 or more, 5,000 or more, or 8,000 or more, and may be 150,000 or less, 100,000 or less, or 50,000 or less. When the weight average molecular weight of the modifying polymer is within these numerical ranges, the modifying polymer is likely to have satisfactory compatibility with other components, and the resin molded article can be especially excellent mechanical characteristics in view of strength, elongation, and the like.

As will be understood by those ordinarily skilled in the art, the modifying polymer can be obtained by a conventional synthesis method by using conventionally available raw materials as starting materials. For example, the modifying polymer may be a reaction product between a bifunctional alcohol having a polyoxyalkylene chain and a hydroxyl group at both terminals (a polyalkylene glycol or the like) and a compound having a functional group that reacts with a hydroxyl group (an isocyanate group or the like) and a cyclic group or a branched group (a bifunctional isocyanate or the like). The modifying polymer to be synthesized may contain a branched structure based on side reactions such as trimerization of isocyanate groups. In a case in which a bifunctional alcohol is used as a synthesis raw material, the number average molecular weight of the bifunctional alcohol may be 500 to 200,000.

The structure of the modifier polymer can be characterized by, for example, the molecular weight and the molecular weight distribution, the linking group, and the structure and the proportion of the oxyalkylene structure. Whereas, the structure of the modifying polymer can also be changed significantly by factors other than these, for example, the arrangement of the various constituent units and the steric structure. However, it is generally difficult to check the arrangement of the constituent units by a realistic method. Therefore, in order to characterize the structure of the modifying polymer, there may be occasions in which it is required to define the synthesis conditions or the kinds and proportions of the raw materials used.

The content of the modifying polymer in the curable resin composition may be 1% by mass or more, 3% by mass or more, or 5% by mass or more, based on the mass of the curable resin composition. Thereby, an effect of enhancing the mechanical characteristics of the resin molded article brought by the modifying polymer is particularly significantly provided. The content of the modifying polymer may also be 20% by mass or less, 15% by mass or less, or 10% by mass or more. Thereby, high compatibility with components other than the modifying polymer can be secured. When compatibility is high, a transparent resin molded article that does not undergo phase separation is likely to be obtained.

The radical polymerizable monomers included in the curable resin composition includes a monofunctional radical polymerizable monomer having one radical polymerizable group. The radical polymerizable monomers may include, as the monofunctional radical polymerizable monomer, for example, an alkyl (meth)acrylate and/or acrylonitrile.

The alkyl (meth)acrylate may be an alkyl (meth)acrylate having an alkyl group with 1 to 16 carbon atoms which may have a substituent (an ester of (meth)acrylic acid and an alkyl alcohol having 1 to 16 carbon atoms, which may have a substituent). The substituent that may be carried by the alkyl (meth)acrylate having an alkyl group with 1 to 16 carbon atoms may contain an oxygen atom and/or a nitrogen atom.

When the radical polymerizable monomers include an alkyl (meth)acrylate having an alkyl group with 1 to 16 carbon atoms, the scratch resistance of the resin molded article tends to increase. When an alkyl (meth)acrylate having an alkyl group with a small carbon number is used, the scratch resistance of the resin molded article after curing tends to increase. From such a viewpoint, the radical polymerizable monomers may include an alkyl (meth)acrylate having an alkyl group with 1 to 10 carbon atoms or 1 to 8 carbon atoms which may have a substituent, as the monofunctional radical polymerizable monomer.

The proportion of the alkyl (meth)acrylate having 1 to 16 carbon atoms which may have a substituent, in the curable resin composition may be 10 mol % or higher, 15 mol % or higher, or 20 mol % or higher, and may be 95 mol % or less, 90 mol % or less, or 85 mol % or less, based on the total amount of the radical polymerizable monomers. When the proportion of the alkyl (meth)acrylate having 1 to 16 carbon atoms which may have a substituent is within these ranges, a resin molded article having excellent adhesiveness and scratch resistance is likely to be obtained. The proportion of the alkyl (meth)acrylate having 10 or fewer carbon atoms which may have a substituent, may be 8 mol % or more, 10 mol % or more, or 15 mol % or more, and may be 55 mol % or less, 45 mol % or less, or 25 mol % or less, based on the total amount of the radical polymerizable monomers. When the proportion of the alkyl (meth)acrylate having an alkyl group with 10 or fewer carbon atoms which may have a substituent is within these ranges, a resin molded article having satisfactory adhesiveness and scratch resistance is more likely to be formed.

Examples of the alkyl (meth)acrylate having 1 to 16 carbon atoms which may have a substituent include ethyl acrylate, ethyl methacrylate, n-butyl acrylate, n-butyl methacrylate, isobutyl acrylate, isobutyl methacrylate, hexyl acrylate, hexyl methacrylate, 2-ethylhexyl acrylate (EHA), 2-ethylhexyl methacrylate, 2-hydroxyethyl methacrylate, 2-hydroxypropyl methacrylate, 2-hydroxy-1-methylethyl methacrylate, 2-methoxyethyl acrylate (MEA), N,N-dimethylaminoethyl acrylate, and glycidyl methacrylate. These can be used singly or in combination of two or more kinds thereof. For example, 2-ethylhexyl acrylate and 2-methoxyethyl acrylate can be used in combination as the alkyl (meth)acrylate having 1 to 16 carbon atoms which may have a substituent.

The radical polymerizable monomers may include acrylonitrile as the monofunctional radical polymerizable monomer. Thereby, the folding resistance of the resin molded article tends to increase. A combination of acrylonitrile and a (meth)acrylate having an alkyl group with 1 to 16 (or 1 to 10) carbon atoms is particularly advantageous in order to obtain a resin molded article having enhanced folding resistance.

The proportion of the acrylonitrile in the curable resin composition may be 40 mol % or more, 50 mol % or more, or 70 mol % or more, and may be 90 mol % or less, 85 mol % or less, or 80 mol % or less, based on the total amount of the radical polymerizable monomers. When the proportion of the acrylonitrile is within these ranges, a more advantageous effect is obtained in view of folding resistance, high elongation, and high strength.

The radical polymerizable monomers may include one kind or two or more kinds of compounds selected from a vinyl ether, styrene, and a styrene derivative, as the monofunctional radical polymerizable monomer. Examples of the vinyl ether include vinyl butyl ether, vinyl octyl ether, vinyl-2-chloroethyl ether, vinyl isobutyl ether, vinyl dodecyl ether, vinyl octadecyl ether, vinyl phenyl ether, and vinyl cresyl ether. Examples of the styrene derivative include an alkylstyrene, an alkoxystyrene (α-methoxystyrene, p-methoxystyrene, or the like), and m-chlorostyrene.

The radical polymerizable monomers may also include another monofunctional radical polymerizable monomer and/or a polyfunctional radical polymerizable monomer. Examples of the other monofunctional radical polymerizable monomer include vinylphenol, N-vinylcarbazole, 2-vinyl-5-ethylpyridine, isopropenyl acetate, vinyl isocyanate, vinyl isobutyl sulfide, 2-chloro-3-hydroxypropene, vinyl strearate, p-vinyl benzyl ethyl carbinol, vinyl phenyl sulfide, allyl acrylate, α-chloroethyl acrylate, allyl acetate, 2,2,6,6-tetratnethylpiperidinyl methacrylate, N,N-diethylvinyl carbamate, vinyl isopropenyl ketone, N-vinylcaprolactone, vinyl formate, p-vinyl benzyl methyl carbinol, vinyl ethyl sulfide, vinylferrocene, vinyl dichloroacetate, N-vinylsuccinimide, allyl alcohol, norbornadiene, diallylmelamine, vinyl chloroacetate, N-vinylpyrrolidone, vinyl methyl sulfide, N-vinyloxazolidone, vinyl methyl sulfoxide, N-vinyl-N′-ethylurea, and acenaphthalene.

The various radical polymerizable monomers listed above as examples can be used singly or in combination of two or more kinds thereof.

The curable resin composition may also include a radical polymerization initiator for polymerizing the radical polymerizable monomers. The radical polymerization initiator may be a thermal radical polymerization initiator, a photoradical polymerization initiator, or a combination thereof. The content of the radical polymerization initiator may be appropriately adjusted in a conventional range; however, the content may be, for example, 0.01% to 5% by mass based on the mass of the curable resin composition.

Examples of the thermal radical polymerization initiator include organic peroxides such as a ketone peroxide, a peroxy ketal, a dialkyl peroxide, a diacyl peroxide, a peroxy ester, a peroxy dicarbonate, and a hydroperoxide; persulfates such as sodium persulfate, potassium persulfate, and ammonium persulfate; azo compounds such as 2,2′-azobis-isobutyronitrile (AIBN), 2,2′-azobis-2,4-dimethylvaleronitrile (ADVN), 2,2′-azobis-2-methylbutyronitrile, and 4,4′-azobis-4-cyanovaleric acid; alkyl metals such as sodium ethoxide and tert-butyllithium; and silicon compounds such as 1-methoxy-1-(trimethylsiloxy)-2-methyl-1-propene.

A thermal radical polymerization initiator and a catalyst may also be used in combination. Examples of this catalyst include metal salts; and reducing compounds such as tertiary amine compounds, such as N,N,N′,N′-tetramethylethylenediamine.

Examples of the photoradical polymerization initiator include 2,2-dimethoxy-1,2-diphenylethan-1-one. A commercially available product thereof is Irgacure 651 (manufactured by Ciba-Geigy Japan, Ltd.).

The curable resin composition may also include a solvent as necessary, or may be substantially solvent-free. Examples of the solvent that may be used include aromatic hydrocarbon-based solvents such as toluene and xylene; ketone-based solvents such as methyl ethyl ketone and methyl isobutyl ketone; ester-based solvents such as ethyl acetate and butyl acetate; and aliphatic hydrocarbon-based solvents such as hexane and methylcyclohexane. These can be used singly or in combination of two or more kinds thereof.

The content of the solvent included in the curable resin composition can be selected as appropriate according to the purpose or the like. For example, the curable resin composition can be used as a solution or a dispersion liquid, in which the concentration of the solid content (components other than a solvent) is about 20% by mass to 99% by mass of the total amount.

In the curable resin composition, if necessary, a binder polymer, a photocolor developer, a thermal color development inhibitor, a plasticizer, a pigment, a filler, a flame retardant, a stabilizer, a tackifier, a leveling agent, a peeling accelerator, an oxidation inhibitor, a fragrance, an imaging agent, a thermal crosslinking agent, and the like may also be incorporated. These can be used singly or in combination of two or more kinds thereof. In a case in which the curable resin composition includes those other components, the content of the components may be 0.01% by mass or more, or may be 30% by mass or less, based on the total mass of the curable resin composition.

The curable resin composition may be in any of a liquid form, a semisolid form, and a solid form. It is also acceptable that the curable resin composition before being cured is in a film form.

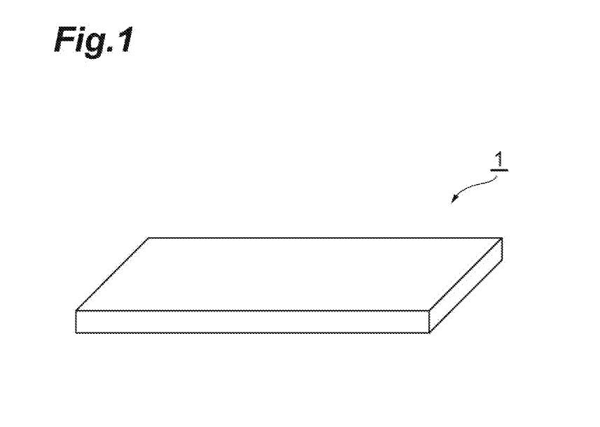

The curable resin composition can be used as a composition for molding, which is intended for framing a resin molded article, or as a paint, a surface coating material, an adhesive, or the like. The resin molded article thus formed can have an arbitrary shape, including a film shape, a sheet shape, a plate shape, a fibrous shape, a rod shape, a columnar shape, a cylindrical shape, a flat plate shape, a disc shape, a helical shape, a spherical shape, and a ring shape. FIG. 1 is a perspective view illustrating an embodiment of the resin molded article. The resin molded article 1 of FIG. 1 is an example of a flat plate-shaped molded article. The resin molded article obtained by curing may also be further processed by various methods such as machine processing.

The resin molded article can be produced by a method including a step of producing a polymer by radical polymerization of radical polymerizable monomers in a curable resin composition. Radical polymerization of the radical polymerizable monomers can be initiated by heating or irradiation with active rays such as ultraviolet radiation. A film-shaped resin molded article can be formed by, for example, applying the curable resin composition on the surface of a base material, drying the applied curable resin composition as necessary, and then subjecting the radical polymerizable monomers to radical polymerization by means of heat and/or light.

The temperature for the polymerization reaction is not particularly limited; however, in a case in which the resin composition includes a solvent, the temperature is preferably lower than or equal to the boiling point of the solvent. It is preferable that the polymerization reaction is carried out in an atmosphere of an inert gas such as nitrogen gas, helium gas, or argon gas. Thereby, inhibition of polymerization by oxygen is suppressed, and a resin molded article having satisfactory product quality can be stably obtained.

Composition for Molding

A composition for molding according to an embodiment includes radical polymerizable monomers including a radical polymerizable compound represented by Formula (I):

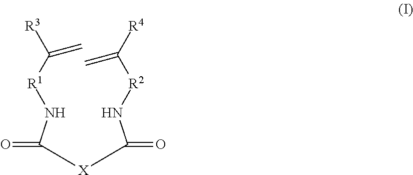

and a monofunctional radical polymerizable monomer; and a second polymer. In Formula (I), X, R¹, and R² each independently represent a divalent organic group; and R³ and R⁴ each independently represent a hydrogen atom or a methyl group. When the radical polymerizable monomers are polymerized in the composition for molding, a first polymer composed of monomer units derived from those radical polymerizable monomers is produced. Thereby, the reaction product is cured, and a resin molded article (cured article) is formed. The first polymer is usually formed as a polymer separate from the second polymer in the molded article, without being bonded to the second polymer by covalent bonding.

The first polymer can contain a cyclic monomer unit represented by the following Formula (II), which is derived from the compound of Formula (I). It is considered that the cyclic monomer unit of Formula (II) contributes to the manifestation of unique characteristics such as shape memory properties of the resin molded article. However, it is not necessarily essential for the first polymer to contain the monomer unit of Formula (II).

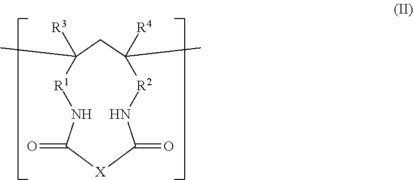

X in Formulae (I) and (II) may also be, for example, a group represented by the following Formula (10):

*—Z¹—(CH₂)ᵢ—Y—(CH₂)ⱼ—Z²—* (10)

In Formula (10), Y represents a cyclic group which may have a substituent; Z¹ and Z² each independently represent a functional group containing an atom selected from a carbon atom, an oxygen atom, a nitrogen atom, and a sulfur atom; and i and j each independently represent an integer from 0 to 2. The symbol * represents a linking point (this is also the same for other formulae). It is considered that when X represents a group of Formula (10), the cyclic monomer unit of Formula (II) may be particularly easily formed. The configuration of Z¹ and Z² with respect to the cyclic group Y may be the cis-position or may be the trans-position. Z¹ and Z² may also be groups represented by —O—, —OC(═O)—, —S—, —OC(═S)—, —NR¹⁰— (wherein R¹⁰ represents a hydrogen atom or an alkyl group), or —ONH—.

Y may be a cyclic group having 2 to 10 carbon atoms, and may also contain a heteroatom selected from an oxygen atom, a nitrogen atom, and a sulfur atom. This cyclic group Y may be, for example, an alicyclic group, a cyclic ether group, a cyclic amine group, a cyclic thioether group, a cyclic ester group, a cyclic amide group, a cyclic thioester group, an aromatic hydrocarbon group, a heteroaromatic hydrocarbon group, or a combination thereof. The cyclic ether group may be a cyclic group carried by a monosaccharide or a polysaccharide. Specific examples of Y include, but are not particularly limited to, cyclic groups represented by the following Formulae (11), (12), (13), (14), and (15). From the viewpoint of stress relaxation characteristics of the resin molded article, Y may also be a group of Formula (11) (particularly, a 1,2-cyclohexanediyl group).

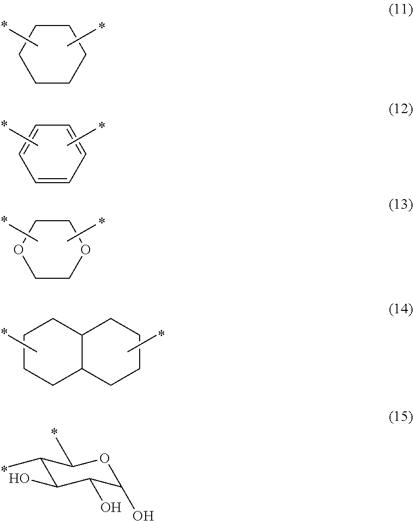

R¹ and R² in Formulae (I) and (II) may be identical with or different from each other, and may each represent a group represented by the following Formula (20).

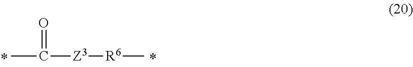

In Formula (20), R⁶ represents a hydrocarbon group (alkylene group or the like) having 1 to 8 carbon atoms and is bonded to a nitrogen atom in Formula (I) or (II). Z³ represents a group represented by —O— or —NR¹⁰— (wherein R¹⁰ represents a hydrogen atom or an alkyl group). It is considered that when R¹ and R² both represent a group of Formula (20), a cyclic monomer unit of Formula (II) may be particularly easily formed. The number of carbon atoms of R⁶ may be 2 or more and may be 6 or less, or 4 or less.

One specific example of the radical polymerizable compound of Formula (I) is a compound represented by the following Formula (Ia). Here, Y, Z¹, Z², i, and j have the same definitions as Y, Z¹, Z², i, and j of Formula (10), respectively.

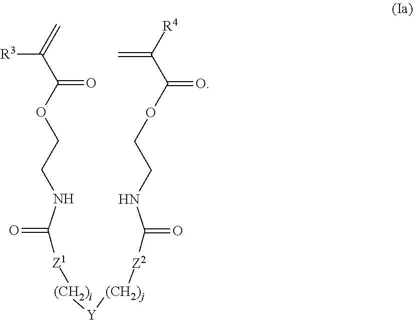

Examples of the compound of Formula (Ia) include compounds represented by the following Formulae (I-1), (I-2), (I-3), (I-4), (I-5), (I-6), (I-7), or (I-8).

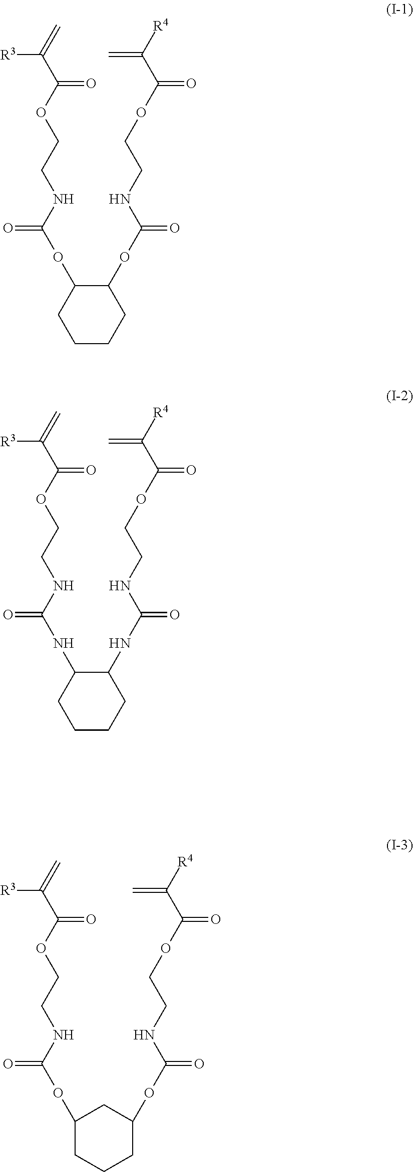

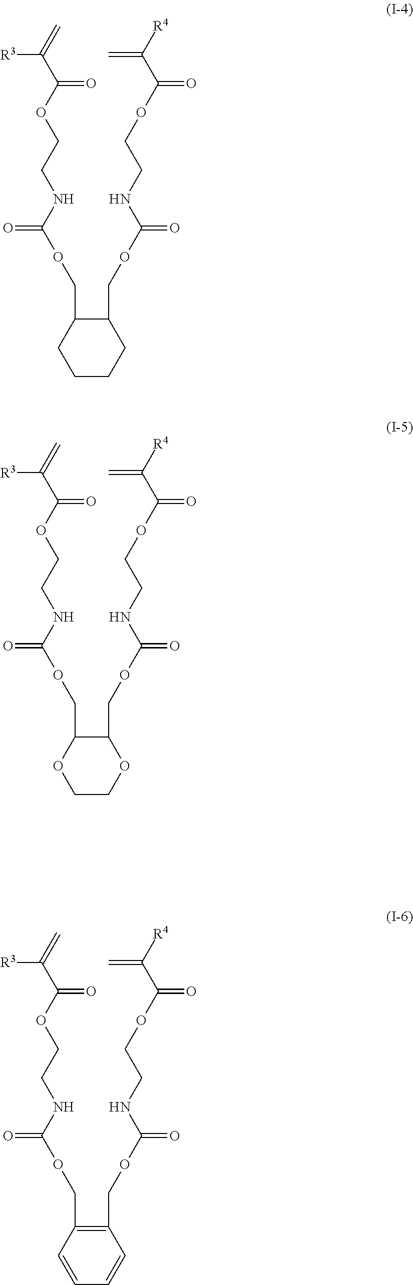

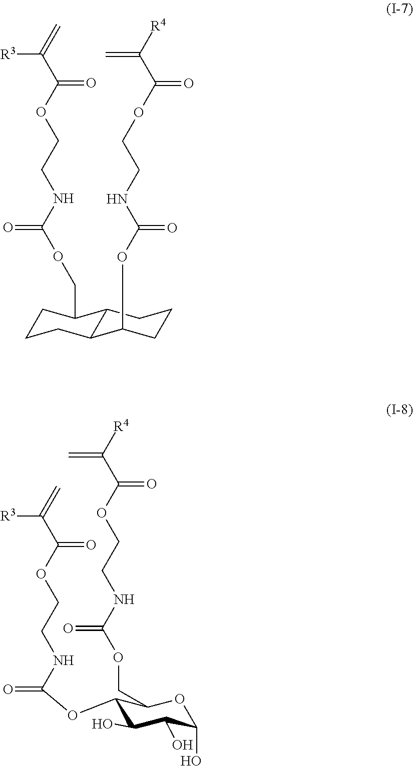

The compounds listed above as examples can be used singly or in combination of two or more kinds thereof.

The proportion of the radical polymerizable compound of Formula (I) in the composition for molding may be 0.01 mol % or more, 0.1 mol % or more, or 0.5 mol % or more, and may be 10 mol % or less, 5 mol % or less, or 1 mol % or less, based on the total amount of the radical polymerizable monomers. When the proportion of the radical polymerizable compound of Formula (I) is within these ranges, a more advantageous effect is obtained from the viewpoint that a cured article having excellent mechanical characteristics such as elongation, strength, and folding resistance is obtained.

The compound of Formula (I) can be synthesized by a conventional synthesis method by using conventionally available raw materials as starting materials, as will be understood by those ordinarily skilled in the art. For example, a compound of Formula (I) can be synthesized by a reaction between a cyclic diol compound or a cyclic diamine compound and a compound having a (meth)acryloyl group and an isocyanate group.

The radical polymerizable monomers in the composition for molding may include an alkyl (meth)acrylate and/or acrylonitrile as a monofunctional radical polymerizable monomer.

The alkyl (meth)acrylate may be an alkyl (meth)acrylate having an alkyl group with 1 to 16 carbon atoms, which may have a substituent (an ester between (meth)acrylic acid and an alkyl alcohol having 1 to 16 carbon atoms which may have a substituent). The substituent that may be carried by the alkyl (meth)acrylate having an alkyl group with 1 to 16 carbon atoms may contain an oxygen atom and/or a nitrogen atom.

When the radical polymerizable monomers include an alkyl (meth)acrylate having an alkyl group with 1 to 16 carbon atoms, advantageous effects that the elastic modulus, glass transition temperature (Tg), and mechanical characteristics such as elongation and strength, of the cured article can be controlled, are obtained.

The proportion of the alkyl (meth)acrylate having 1 to 16 carbon atoms which may have a substituent, in the composition for molding may be 10 mol % or more, 15 mol % or more, or 20 mol % or more, and may be 95 mol % or less, 90 mol % or less, or 85 mol % or less, based on the total amount of the radical polymerizable monomers. When the proportion of the alkyl (meth)acrylate having 1 to 16 carbon atoms which may have a substituent is within these ranges, a more advantageous effect is obtained from the viewpoint of obtaining a cured article having excellent mechanical characteristics such as elongation and strength and excellent folding resistance.

When an alkyl (meth)acrylate having an alkyl group with a small number of carbon atoms is used, there is a tendency that the elastic modulus of the resin molded article obtainable after curing increases, and shape memory properties are easily manifested. From such a viewpoint, the radical polymerizable monomers may include an alkyl (meth)acrylate having an alkyl group with 10 or fewer carbon atoms which may have a substituent, as a monofunctional radical polymerizable monomer. The proportion of the alkyl (meth)acrylate having 10 or fewer carbon atoms which may have a substituent may be 8 mol % or more, 10 mol % or more, or 15 mol % or more, and may be 55 mol % or less, 45 mol % or less, or 25 mol % or less, based on the total amount of the radical polymerizable monomers. When the proportion of the alkyl (meth)acrylate having an alkyl group with 10 or fewer carbon atoms which may have a substituent is within these ranges, a more advantageous effect is obtained from the viewpoint that a resin molded article having an elastic modulus that is high to a certain extent and having shape memory properties may be easily formed. From a similar point of view, the radical polymerizable monomers may also include a (meth)acrylate having an alkyl group with 8 or fewer carbon atoms which may have a substituent, and the proportion of the (meth)acrylate may be in the value ranges described above.

Examples of the alkyl (meth)acrylate having 1 to 16 carbon atoms which may have a substituent, include ethyl acrylate, ethyl methacrylate, n-butyl acrylate, n-butyl methacrylate, isobutyl acrylate, isobutyl methacrylate, hexyl acrylate, hexyl methacrylate, 2-ethylhexyl acrylate (EHA), 2-ethylhexyl methacrylate, 2-hydroxyethyl methacrylate, 2-hydroxypropyl methacrylate, 2-hydroxy-1-methylethyl methacrylate, 2-methoxyethyl acrylate (MEA), N,N-dimethylaminoethyl acrylate, and glycidyl methacrylate. These can be used singly or in combination of two or more kinds thereof.

When the radical polymerizable monomers include acrylonitrile, there is a tendency that a resin molded article that has excellent mechanical characteristics such as elongation and strength and excellent folding resistance, has an elastic modulus that is high to a certain extent, and has shape memory properties is easily formed. A combination of acrylonitrile and a (meth)acrylate having an alkyl group with 1 to 16 (or 1 to 10) carbon atoms is particularly advantageous for obtaining a resin molded article having a high elastic modulus. The proportion of acrylonitrile in the composition for molding may be 40 mol % or more, 50 mol % or more, or 70 mol % or more, and may be 90 mol % or less, 85 mol % or less, or 80 mol % or less, based on the total amount of the radical polymerizable monomers. When the proportion of acrylonitrile is within these ranges, a more advantageous effect is obtained in view of having rapid shape restoration.

The radical polymerizable monomers may also include one kind or two or more kinds of compounds selected from a vinyl ether, styrene, and a styrene derivative as a monofunctional radical polymerizable monomer. Examples of the vinyl ether include vinyl butyl ether, vinyl octyl ether, vinyl-2-chloroethyl ether, vinyl isobutyl ether, vinyl dodecyl ether, vinyl octadecyl ether, vinyl phenyl ether, and vinyl cresyl ether. Examples of the styrene derivative include an alkylstyrene, an alkoxystyrene (α-methoxystyrene, p-methoxystyrene, or the like), and m-chlorostyrene.

The radical polymerizable monomers may also include another monofunctional radical polymerizable monomer and/or a polyfunctional radical polymerizable monomer. Examples of the other monofunctional radical polymerizable monomer include vinyl phenol, N-vinyl carbazole, 2-vinyl-5-ethylpyridine, isopropenyl acetate, vinyl isocyanate, vinyl isobutyl sulfide, 2-chloro-3-hydroxypropene, vinyl stearate, p-vinyl benzyl ethyl carbinol, vinyl phenyl sulfide, allyl acrylate, α-chloroethyl acrylate, allyl acetate, 2,2,6,6-tetramethyl piperidinyl methacrylate, N,N-diethyl vinyl carbamate, vinyl isopropenyl ketone, N-vinyl caprolactone, vinyl formate, p-vinyl benzyl methyl carbinol, vinyl ethyl sulfide, vinylferrocene, vinyl dichloroacetate, N-vinylsuccinimide, allyl alcohol, norbornadiene, diallyl melamine, vinyl chloroacetate, N-vinylpyrrolidone, vinyl methyl sulfide, N-vinyloxazolidone, vinyl methyl sulfoxide, N-vinyl-N′-ethylurea, and acenaphthalene.

The various radical polymerizable monomers listed above as examples can be used singly or in combination of two or more kinds thereof.

The composition for molding includes the radical polymerizable monomers explained above, and a linear or branched second polymer. The second polymer may be a polymer containing two or more linear chains and linking groups that connect the terminals of the linear chains. This polymer contains, for example, a molecular chain represented by the following Formula (B). In Formula (B), R²⁰ represents a monomer unit that constitutes a linear chain; n¹, n², and n³ each independently represent an integer of 1 or greater; and L represents a linking group. A plurality of R²⁰'s and a plurality of Us in the same molecule may be respectively identical or different.

*R²⁰ₙ_{¹}LR²⁰ₙ_{²}LR²⁰ₙ_{³}* (B)

The linear chain composed of the monomer unit R²⁰ may be a molecular chain derived from a polyether, a polyester, a polyolefin, a polyorganosiloxane, or a combination thereof. The respective linear chains may be polymers, or may be oligomers.

Examples of a linear chain derived from a polyether include polyoxyalkylene chains such as a polyoxyethylene chain, a polyoxypropylene chain, a polyoxybutylene chain, and combinations thereof. The polyoxyethylene chain is derived from a polyether such as a polyalkylene glycol. Examples of a linear chain derived from a polyolefin include a polyethylene chain, a polypropylene chain, a polyisobutylene chain, and combinations thereof. Examples of a linear chain derived from a polyester include a poly-ε-caprolactone chain. Examples of a linear chain derived from a polyorganosiloxane include a polydimethylsiloxane chain. The second polymer may contain these singly or a combination of two or more kinds selected from these.

The number average molecular weight of each of the linear molecular chains that constitute the second polymer is not particularly limited; however, the number average molecular weight may be, for example, 1,000 or more, 3,000 or more, or 5,000 or more, and may be 80,000 or less, 50,000 or less, or 20,000 or less. According to the present specification, unless particularly defined otherwise, the number average molecular weight means a value that is determined by gel permeation chromatography and calculated relative to polystyrene standards.

The linking group L is an organic group containing a cyclic group, or a branched organic group. The linking group L may also be, for example, a divalent group represented by the following Formula (30).

*—Z⁵—R³⁰—Z⁶—* (30)

R³⁰ represents a cyclic group; a group containing two or more cyclic groups linked to each other directly or via an alkylene group; or a branched organic group that contains carbon atoms and may contain a heteroatom selected from an oxygen atom, a nitrogen atom, a sulfur atom, and a silicon atom. Z⁵ and Z⁶ each represent a divalent group that links R³⁰ to a linear chain, and represents a group represented by, for example, —NHC(═O)—, —NHC(═O)O—, —O—, —OC(═O)—, —S—, —SC(═O)—, or —NR¹⁰— (wherein R¹⁰ represents a hydrogen atom or an alkyl group). According to the present specification, the terminal atoms of the linear chain (atoms originating from a monomer that constitutes the linear chain) are usually not construed as atoms that constitute Z⁵ or Z⁶. In a case in which it is not clear whether the terminal atoms of the linear chain are atoms originating from a monomer, the atoms may be construed to be included in any of a linear chain and a linking group.

The cyclic group contained in the linking group L may contain a heteroatom selected from a nitrogen atom and a sulfur atom. Examples of the cyclic group contained in the linking group L include an alicyclic group, a cyclic ether group, a cyclic amine group, a cyclic thioether group, a cyclic ester group, a cyclic amide group, a cyclic thioester group, an aromatic hydrocarbon group, a heteroaromatic hydrocarbon group, and a combination thereof. Specific examples of the cyclic group contained in the linking group L include a 1,4-cyclohexanediyl group, a 1,2-cyclohexanediyl group, a 1,3-cyclohexanediyl group, a 1,4-benzenediyl group, a 1,3-benzenediyl group, a 1,2-benzenediyl group, and a 3,4-furandiyl group.

Examples of the branched organic group contained in the linking group L (for example, R³⁰ in Formula (30)) include a lysinetriyl group, a methylsilanetriyl group, and a 1,3,5-cyclohexanetriyl group.

The linking group L represented by Formula (30) may be a group represented by the following Formula (31). R³¹ in Formula (31) represents a single bond or an alkylene group. R³¹ may also be an alkylene group having 1 to 3 carbon atoms. Z⁵ and Z⁶ have the same definitions as Z⁵ and Z⁶ of Formula (30), respectively.

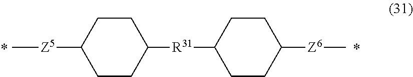

The weight average molecular weight of the second polymer is not particularly limited; however, for example, the weight average molecular weight may be 5,000 or more, 7,000 or more, or 9,000 or more, and may be 100,000 or less, 80,000 or less, or 60,000 or less. When the weight average molecular weight of the second polymer is within these numerical ranges, there is a tendency that satisfactory compatibility with components other than the second polymer and satisfactory general characteristics of the resin molded article are easily obtained.

As will be understood by those ordinarily skilled in the art, the second polymer can be obtained by a conventional synthesis method by using conventionally available raw materials as starting materials. For example, the second polymer can be synthesized by a reaction between a mixture including a polyalkylene glycol, a polyester, a polyolefin, a polyorganosiloxane, which have reactive terminal groups (hydroxyl groups or the like), or a combination thereof, and a compound having a reactive functional group (an isocyanate group or the like) and a cyclic group or a branched group. The second polymer to be synthesized may also include a branched structure based on a side reaction such as trimerization of isocyanate groups.

The composition for molding may also include a polymerization initiator for polymerizing the radical polymerizable monomers. The polymerization initiator may be a thermal radical polymerization initiator, a photoradical polymerization initiator, or a combination thereof. The content of the polymerization initiator may be adjusted as appropriate in a conventional range; however, the content may be, for example, 0.01% to 5% by mass based on the mass of the composition for molding.

Examples of the thermal radical polymerization initiator include organic peroxides such as a ketone peroxide, a peroxy ketal, a dialkyl peroxide, a diacyl peroxide, a peroxy ester, a peroxy dicarbonate, and a hydroperoxide; persulfates such as sodium persulfate, potassium persulfate, and ammonium persulfate; azo compounds such as 2,2′-azobisisobutyronitrile (AIBN), 2,2′-azobis-2,4-dimethylvaleronitrile (ADVN), 2,2′-azobis-2-methylbutyronitrile, and 4,4′-azobis-4-cyanovaleric acid; alkyl metals such as sodium ethoxide and tert-butyllithium; and silicon compounds such as 1-methoxy-1-(trimethylsiloxy)-2-methyl-1-propene.

A thermal radical polymerization initiator and a catalyst may also be used in combination. Examples of this catalyst include metal salts, and reducing compounds such as a tertiary amine compound, such as N,N,N′,N′-tetramethylethylenediamine.

Examples of the photoradical polymerization initiator include 2,2-dimethoxy-1,2-diphenylethan-1-one. Commercially available products thereof include Irgacure 651 (manufactured by Ciba-Geigy Japan, Ltd.).

The composition for molding may include a solvent or may be substantially solvent-free. The composition for molding may be in any of a liquid form, a semisolid form, and a solid form. The composition for molding before being cured may be in a film form.

The resin molded article can be produced by a method including a step of producing a first polymer by radical polymerization of the radical polymerizable monomers in the composition for molding. Radical polymerization of the radical polymerizable monomers can be initiated by heating, or irradiation with active rays such as ultraviolet radiation.

The shape and size of the resin molded article (cured article) are not particularly limited, and for example, a resin molded article having an arbitrary shape can be obtained by curing the composition for molding that has been filled in a predetermined mold. The resin molded article may have, for example, a fibrous shape, a rod shape, a columnar shape, a cylindrical shape, a flat plate shape, a disc shape, a helical shape, a spherical shape, or a ring shape. The molded article obtained after curing may also be further processed by various methods such as machine processing.

The temperature of the polymerization reaction is not particularly limited; however, in a case in which the composition for molding includes a solvent, it is preferable that the temperature is lower than or equal to the boiling point of the solvent. It is preferable that the polymerization reaction is carried out in an atmosphere of an inert gas such as nitrogen gas, helium gas, or argon gas. Thereby, polymerization inhibition by oxygen is suppressed, and a molded article having satisfactory product quality can be stably obtained.

It is considered that when the radical polymerizable monomers including the radical polymerizable compound of Formula (I) are polymerized, cyclic monomer units of Formula (II) are formed. When the radical polymerizable monomers are polymerized in the presence of the first polymer, a structure in which the second polymer penetrates through the cyclic moiety in at least a portion of the cyclic monomer units of Formula (II) may be formed. The following Formula (III) schematically represents a structure in which the second polymer (B) penetrates through a cyclic moiety of a monomer unit of Formula (II) contained in the first polymer (A). R⁵ in Formula (III) is a monomer unit derived from a radical polymerizable monomer other than the radical polymerizable compound of Formula (I). When a structure such as Formula (III) is formed, a crosslinked network structure like a three-dimensional copolymer is formed by the first polymer and the second polymer. In this network structure, it is considered that the degree of freedom in motion of the second polymer that penetrates through a cyclic moiety is maintained at a relatively high level. Such a structure may be referred to as a slide-ring structure by those ordinarily skilled in the art, and the inventors of the present invention speculate that this slide-ring structure contributes to the manifestation of unique characteristics such as the shape memory properties of the resin molded article. It is not technically easy to directly confirm that a slide-ring structure has been formed; however, for example, since the stress-strain curve obtained by a tensile test of the resin molded article is a so-called J-shaped curve, formation of the slide-ring structure is suggested. However, the resin molded article may not necessarily contain such a slide-ring structure.

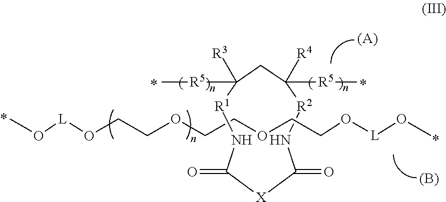

In the example of Formula (III), the second polymer (B) has a plurality of polyoxyethylene chain and a linking group L that connects a terminals of the polyoxyehylene chains. Since the linking group L is bulky compared to a polyoxyethylene chain, the state in which the second polymer penetrates through a cyclic moiety of the monomer unit of Formula (II) can be easily maintained, as in the case of a polyrotaxane. The second polymer can be selected as appropriate based on the balance in the size, inclusion ability, and the like of the cyclic monomer unit, and the characteristics of polyrotaxanes.

Although a resin molded article in which the first polymer has been produced and cured may have or may not have shape memory properties, a resin molded article having shape memory properties can be obtained by appropriately selecting the kinds of the radical polymerizable monomers. According to the present specification, the “shape memory properties” mean properties by which, when a resin molded article is deformed by an external force at room temperature (for example, 25° C.), the resin molded article retains the shape after deformation at room temperature and restores the original shape when heated to a high temperature under no-load conditions. However, the resin molded article may not perfectly restore the same shape as the original shape as a result of heating. The temperature of heating for shape restoration is, for example, 70° C.

In a case in which a cured resin molded article has shape memory properties, usually, the shape of the resin molded article possessed at the time point at which a first polymer is produced and cured becomes a basic shape. The resin molded article that has been deformed by an external force is deformed so as to approach this basic shape as a result of heating. By curing the resin molded article inside a mold having a predetermined shape, a resin molded article having a desired shape as the basic shape can be obtained.

The storage modulus at 25° C. of the resin molded article is not particularly limited; however, the storage modulus may be 0.5 MPa or higher. A resin molded article having a storage modulus of 0.5 MPa or higher typically has shape memory properties. The elastic modulus of the resin molded article may be 1.0 MPa or higher, or 10 MPa or higher, and may be 10 GPa or lower, 5 GPa or lower, or 500 MPa or lower. As the storage modulus is higher, the resin molded article tends to easily retain the shape after deformation. When the resin molded article has a storage modulus of an appropriate magnitude, the resin molded article tends to easily restore the original shape at the time of heating. The elastic modulus of the resin molded article can be controlled based on, for example, the kinds and mixing ratios of the radical polymerizable monomers, the molecular weight of the second polymer, and the amount of the radical polymerization initiator.

### EXAMPLES

Hereinafter, the present invention will be more specifically described by way of Examples. However, the present invention is not intended to be limited to these Examples.

Curable Resin Composition

1. Synthesis of Polymer Containing Polyoxyalkylene Chain (Modifying Polymer)

Polymer 1

A diol was introduced into a 20-mL pear-shaped flask in the amount (mg) indicated in Table 1, and then the interior of the flask was purged with nitrogen. The content was melted at 115° C. 4,4′-Dicyclohexylmethane diisocyanate (262 mg, 1.0 mmol) was added to the molten liquid, and the mixture was stirred for 24 hours at 115° C. in a nitrogen atmosphere. Thus, Polymer 1 containing polyoxypropylene chains was obtained.

A GPC chromatogram of the resulting polymer was obtained using DMF (N,N-dimethylformamide) containing lithium bromide at a concentration of 10 mM as an eluent, under the conditions of a flow rate of 1 mL/min. From the resulting chromatogram, the number average molecular weight Mn of the polymer was determined as a value calculated relative to polystyrene standards.

The degree of crystallinity of the polyoxyethylene chain of the polymer was calculated based on the amount of heat of fusion that is determined from DSC measurement. The amount of heat of fusion of polyethylene glycol alone and the amount of heat of fusion of the polymer thus synthesized were measured by DSC, and the degree of crystallinity was calculated by the following formula, from those amounts of heat of fusion and the proportion of the polyoxyethylene chain (mass of polyoxyethylene chains/total mass of polyoxyalkylene chains).

Degree of crystallinity=Amount of fusion of polymer×proportion of polyoxyethylene chains (w/w)/amount of heat of fusion of polyethylene glycol (1)

Polymers 2 to 11

Polymers 2 to 10 were synthesized in the same manner as in the case of Polymer 1, except that the kinds and amounts of the diols and the amounts of 4,4′-dicyclohexylmethane diisocyanate were changed to the proportions indicated in Table 1. A polyethylene glycol-polypropylene glycol block copolymer having a number average molecular weight of 8300 was prepared, which was used as Polymer 11.

TABLE 1

| | | | Polymer | Polymer | Polymer | Polymer | Polymer | Polymer | Polymer | Polymer | Polymer | Polymer | Polymer |
|---|---|---|---|---|---|---|---|---|---|---|---|---|---|
| | | Mn | 1 | 2 | 3 | 4 | 5 | 6 | 7 | 8 | 9 | 10 | 11 |
| Diol | Polyethylene | 1500 | — | 300 | 225 | 150 | — | — | — | 150 | 150 | — | — |
| | glycol | 500 | — | — | — | — | — | 100 | — | — | — | — | — |
| | | 4000 | — | — | — | — | — | — | 400 | — | — | — | — |
| | Polypropylene | 4000 | 800 | — | 200 | 400 | — | — | — | 400 | 400 | — | — |
| | glycol | 400 | — | — | — | — | — | 100 | — | — | — | — | — |
| | | 8000 | — | — | — | — | — | — | 800 | — | — | — | — |
| | Polyethylene | 8300 | — | — | — | — | 1600 | — | — | — | — | — | 100 |
| | glycol- | | | | | | | | | | | | |
| | polypropylene | | | | | | | | | | | | |
| | glycol block | | | | | | | | | | | | |
| | copolymer | | | | | | | | | | | | |
| | Bisphenol F | 200 | — | — | — | — | — | — | — | — | — | 400 | — |
| Di- | Dicyclohexyl | 262 | 27 | 27 | 27 | 27 | 27 | 27 | 27 | 14 | 54 | 27 | — |
| isocyanate | diisocyanate | | | | | | | | | | | | |

| | | | | | | | | | | | |
|---|---|---|---|---|---|---|---|---|---|---|---|
| Phase | Liquid | Liquid | Liquid | Liquid | Liquid | Liquid | Liquid | Liquid | Rubber | Solid | Liquid |
| | phase | phase | phase | phase | phase | phase | phase | phase | phase | phase | phase |
| Proportion of polyoxyethylene | 0 | 100 | 53 | 27 | 0 | 50 | 33 | 27 | 27 | 0 | 0 |
| chains (mass %) | | | | | | | | | | | |
| Mn | 15000 | 11000 | 8400 | 9300 | 23000 | 4000 | 32000 | 6400 | 124000 | — | 8300 |
| Degree of crystallinity | 0 | 85.1 | 6.15 | 1.01 | 5.3 | 0 | 4.3 | 0.34 | 2.3 | — | 2.6 |

2. Production of Curable Resin Composition

A modifying polymer, radical polymerizable monomers, and a radical polymerization initiator were mixed at the mass ratios indicated in Table 2 and Table 3, and thus curable resin compositions of Examples and Comparative Examples were obtained.

In Comparative Example 3 and Comparative Example 4, an acrylic rubber (TEISAN RESIN SG-708-61 (trade name), manufactured by Nagase ChemteX Corporation) or a silicone (KR-480 (trade name), manufactured by Shin-Etsu Silicone Co., Ltd.) were used instead of the synthesized modifying polymer.

3. Production of Resin Cured Product

A curable resin composition was introduced into a glass mold having a cavity with a size of 40 mm×50 mm×0.2 mm or 50 mm×50 mm×0.2 mm, the mold was sandwiched between glass plates at the top and the bottom, and the curable resin composition was exposed to light at room temperature with a UV exposure machine (manufactured by Ushio Inc., UV-XeFL). Thus, a plate-shaped resin cured product was obtained. The cumulative amount of light was adjusted to 200 mJ/cm² at 365 nm.

4. Tensile Test

A specimen having a size of 5 mm×50 mm was punched out from the resin cured product. In an area of the specimen corresponding to the chuck distance, marks were made with an oily marker at three sites along the longitudinal direction, and the distances between the various marks were designated as L0 and L0′. A tensile test was performed with a tensile testing machine (manufactured by Shimadzu Corp., EZ-TEST) under the conditions of a measurement temperature of 25° C., a tensile rate of 10 mm/min, and a distance between chucks L1 of 30 mm. For the specimen obtained immediately after fracture, marks at two points where there was no site of fracture between marks were selected from among the three marks, and the distance between those marks L2 was measured. In a case in which the initial length corresponding to this portion was L0, the elongation at break was calculated by formula: (L2−L0)/L0. Alternatively, the elongation at break may also be calculated by formula: (L3−L1)/L1, using the distance between chucks L3 at the time of fracture.

The specimen after fracture was heated for 3 minutes at 70° C., and the distance between marks L4 after heating was measured. The elastic elongation percentage, which represents the proportion of elastic elongation with respect to the elongation at break, was calculated by formula: (L2−L4)/(L2−L0). The distance L2 immediately after fracture may be calculated by formula: L2=L3×(L0/L1), by utilizing the distance between chucks L3. The high elastic elongation percentage implies that the shape restorability after being deformed under stress is superior.

5. Folding Resistance

A film-shaped resin cured product (50 mm×50 mm×0.2 mm) was folded two times, and while in that state, a pressure of 1 N/cm² was applied perpendicularly to the folds for 5 minutes. The fold portions were restored to the original state, and then those portions were observed by visual inspection and with an optical microscope (10 times). An observation was made on the occurrence of any change in the external appearance and any abnormalities such as whitening and voids, compared to the state before folding. The evaluation criteria were as follows.

A: No abnormality was recognized by observation with an optical microscope.

B: No abnormality was recognized by visual inspection; however, abnormalities were recognized with an optical microscope.

C: Abnormalities were recognized by visual inspection, or the folds underwent fracture.

TABLE 2

| | | Example | Example | Example | Example | Example | Example | Example | Example | Example |
|---|---|---|---|---|---|---|---|---|---|---|
| | | 1 | 2 | 3 | 4 | 5 | 6 | 7 | 8 | 9 |
| Modifying | Type | Polymer | Polymer | Polymer | Polymer | Polymer | Polymer | Polymer | Polymer | Polymer |
| polymer | | 1 | 2 | 3 | 4 | 5 | 6 | 7 | 8 | 9 |
| | Amount | 6.3 | 6.3 | 6.3 | 6.3 | 6.3 | 6.3 | 6.3 | 6.3 | 6.3 |
| Radical | 2-Ethylhexyl | 100 | 100 | 100 | 100 | 100 | 100 | 100 | 100 | 100 |
| polymerizable | acrylate | | | | | | | | | |
| monomers | 2-Methoxyethyl | 100 | 100 | 100 | 100 | 100 | 100 | 100 | 100 | 100 |
| | acrylate | | | | | | | | | |
| | Acrylonitrile | — | — | — | — | — | — | — | — | — |
| | Nonanediol | 3.4 | 3.4 | 3.4 | 3.4 | 3.4 | 3.4 | 3.4 | 3.4 | 3.4 |
| | diacrylate | | | | | | | | | |
| Photoradical | Irgacure 651 | 6.2 | 6.2 | 6.2 | 6.2 | 6.2 | 6.2 | 6.2 | 6.2 | 6.2 |
| polymerization | | | | | | | | | | |
| initiator | | | | | | | | | | |

| | | | | | | | | | |
|---|---|---|---|---|---|---|---|---|---|
| External appearance before curing | Trans- | Trans- | Trans- | Trans- | Trans- | Trans- | Whitened | Trans- | Trans- |
| | parent | parent | parent | parent | parent | parent | | parent | parent |
| External appearance of cured product | Trans- | Whitened | Trans- | Trans- | Trans- | Trans- | Whitened | Trans- | Trans- |
| | parent | | parent | parent | parent | parent | | parent | parent |
| Elongation at break (%) | 48 | 52 | 64 | 74 | 62 | 42 | 56 | 39 | 44 |
| Strength at break (kPa) | 110 | 115 | 150 | 170 | 143 | 113 | 102 | 105 | 120 |
| Elastic elongation percentage (%) | 80 | 90 | 95 | 99 | 92 | 82 | 91 | 70 | 80 |
| Folding resistance | A | B | A | A | A | A | A | A | A |

TABLE 3

| | | | | | Comparative | Comparative | Comparative | Comparative |
|---|---|---|---|---|---|---|---|---|
| | | Example 10 | Example 11 | Example 12 | Example 1 | Example 2 | Example 3 | Example 4 |
| Modifying | Type | Polymer 4 | Polymer 4 | Polymer 11 | None | Polymer 10 | Acrylic | Silicone |
| polymer | | | | | | | rubber | |
| | Amount | 10.0 | 6.3 | 6.3 | — | 6.3 | 6.3 | 6.3 |
| Radical | 2-Ethylhexyl | 100 | 100 | 100 | 100 | 100 | 100 | 100 |
| polymerizable | acrylate | | | | | | | |
| monomers | 2-Methoxyethyl | 100 | — | 100 | 100 | 100 | 100 | 100 |
| | acrylate | | | | | | | |
| | Acrylonitrile | — | 100 | — | — | — | — | — |
| | Nonanediol | 3.4 | 3.4 | 3.4 | 3.4 | 3.4 | 3.4 | 3.4 |
| | diacrylate | | | | | | | |
| Photoradical | Irgacure 651 | 6.2 | 6.2 | 6.2 | 6.2 | 6.2 | 6.2 | 6.2 |
| polymerization | | | | | | | | |
| initiator | | | | | | | | |

| | | | | | | | |
|---|---|---|---|---|---|---|---|
| External appearance before curing | Whitened | Transparent | Transparent | — | Sparingly | Phase | Phase |
| | | | | | soluble | separation | separation |
| External appearance of cured product | Whitened | Transparent | Transparent | Transparent | — | — | — |
| Elongation at break (%) | 55 | 49 | 40 | 38 | — | — | — |
| Strength at break (kPa) | 142 | 180 | 123 | 105 | — | — | — |
| Elastic elongation percentage (%) | 80 | 95 | 65 | 50 | — | — | — |
| Folding resistance | B | A | C | C | — | — | — |

The curable resin compositions of Examples 1 to 12 that included Polymers 1 to 9 or 11 containing polyoxyalkylene chains, exhibited high elongation at break compared to the curable resin composition of Comparative Example 1 that did not include any modifying polymer, and also, it was confirmed that the curable resin compositions of Examples 1 to 12 could form resin molded articles having excellent shape restorability after being deformed under stress. Polymer 10 that did not contain polyoxyalkylene chains could not be dissolved in the radical polymerizable monomers, and in Comparative Example 2, a uniform curable resin composition could not be produced. Furthermore, a mixture of an acrylic rubber or a silicone with the radical polymerizable monomers underwent phase separation, and thus, in Comparative Examples 3 and 4 as well, a uniform curable resin composition could not be produced.

### Composition for Molding

### 1. Synthesis

### Synthesis Example 1: Synthesis of trans-1,2-bis(2-acryloyloxyethylcarbamoyloxy)cyclohexane (BACH)

Trans-1,2-cyclohexanediol (2.32 g, 20.0 mmol) was introduced into a 100-mL double-necked pear-shaped flask, and the interior of the flask was purged with nitrogen. Dichloromethane (40 mL) and dibutyltin dilaurate (11.8 μL, 0.10 mol %: 0.020 mmol) were introduced into the flask. To the reaction liquid in the flask, a dichloromethane (4 mL) solution of 2-acryloyloxyethyl isocyanate (5.93 g, 42.0 mmol) was added dropwise from a dropping funnel, and the reaction liquid was stirred for 24 hours at 30° C. to cause a reaction to proceed. After completion of the reaction, diethyl ether was added to the reaction liquid, and the mixture was washed with saturated brine. The organic layer was dried over anhydrous magnesium sulfate, and then the solvent was distilled off under reduced pressure. A solution containing the intended product was isolated from the residue by silica gel chromatography (developing solvent: chloroform), and the solution was concentrated. A crude product thus obtained was purified by recrystallization from diethyl ether and hexane, and thus white crystals of BACH were obtained. The yield amount was 3.78 g, and the yield percentage was 47.4% by mass.

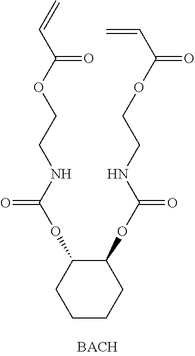 [SMILES: C=CC(=O)OCCNC(=O)O[C@H]1CCCC[C@@H]1OC(=O)NCCOC(=O)C=C]

### Synthesis Example 2: Synthesis of PEG-PPG Oligomer 1

A polyethylene glycol (PEG1500, 750 mg, 0.500 mmol, number average molecular weight 1,500) and a polypropylene glycol (PPG4000, 2,000 mg, 0.500 mmol, number average molecular weight 4,000) were added to a 20-mL pear-shaped flask, and then the interior of the flask was purged with nitrogen. The content was melted at 115° C. 4,4′-Dicyclohexylmethane diisocyanate (262 mg, 1.00 mmol) was added to the molten liquid, and the molten liquid was stirred for 24 hours at 115° C. in a nitrogen atmosphere. Thus, PEG-PPG Oligomer 1 (second polymer containing polyoxyethylene chains and polyoxypropylene chains) was obtained.

The weight average molecular weight (Mw) of resulting Oligomer 1 was 9,300, and the weight average molecular weight/number average molecular weight (Mw/Mn) of Oligomer 1 was 1.65.

### Synthesis Example 3: Synthesis of PEG-PPG Oligomer 2

A polyethylene glycol (PEG1500, 750 mg, 0.500 mmol, number average molecular weight 1,500) and a polypropylene glycol (PPG4000, 2,000 mg, 0.500 mmol, number average molecular weight 4,000) were added to a 20-mL pear-shaped flask, and then the interior of the flask was purged with nitrogen. The content was melted at 115° C. 4,4′-Dicyclohexylmethane diisocyanate (262 mg, 1.00 mmol) and dibutyltin laurate (11.8 μL, 0.10 mol %: 0.020 mmol) were added to the molten liquid, and the molten liquid was stirred for 24 hours at 115° C. in a nitrogen atmosphere. Thus, PEG-PPG Oligomer 2 (second polymer having polyoxyethylene chains and polyoxypropylene chains) was obtained.

The weight average molecular weight (Mw) of resulting Oligomer 2 was 50,000, and the weight average molecular weight/number average molecular weight (Mw/Mn) of Oligomer 2 was 1.95.

### 2. Measurement of Molecular Weight

A GPC chromatograph of an oligomer was obtained by using DMF (N,N-dimethylformamide) containing lithium bromide at a concentration of 10 mM as an eluent, under the conditions of a flow rate of 1 mL/min. From the resulting chromatogram, the number average molecular weight and the weight average molecular weight of the oligomer were determined as values calculated relative to polystyrene standards.

### 3. Composition for Molding and Resin Molded Article Example 2-1

BACH of Synthesis Example 1 (27.7 mg, 69.5 μmop, PEG-PPG Oligomer 1 of Synthesis Example 2 (34.5 mg, 2.88 μmop, 2-ethylhexyl acrylate (2-EHA, 553 mg, 3.00 mmol), acrylonitrile (AN, 390 mg, 3.00 mmol), and Irgacure 651 (15.5 mg, 60.5 μmol) were heated and melted in a sample bottle, and thus a mixed liquid (composition for molding) was produced.

The resulting mixed liquid was poured into a stainless steel metal mold having a dimension of length×width×depth of 46 mm×10 mm×1 mm, and the metal mold was covered with a transparent sheet made of polyethylene terephthalate. The mixed liquid was photocured by irradiating the mixed liquid with UV (ultraviolet radiation) at room temperature (25° C.; hereinafter, the same) from above the transparent sheet for 30 minutes, and thus a film-shaped molded article was obtained.

A tube made of polytetrafluoroethylene (trade name: NAFLON (registered trademark) BT tube 1/8B) having an inner diameter of 1.59 mmϕ, an outer diameter of 3.17 mmϕ, and a thickness of 0.79 mm was twined around a stainless steel tube having an outer form of 10 mmϕ. The twined tube was filled with the mixed liquid, and the mixed liquid in the tube was photocured by irradiating the mixed liquid with ultraviolet radiation for 30 minutes at room temperature. Subsequently, a spiral-shaped molded article was taken out from the tube.

The mixed liquid filled in a cup-shaped mold made of polyethylene was photocured by irradiating the mixed liquid with ultraviolet radiation for 30 minutes at room temperature. A cup-shaped molded article was taken out from the mold as a molded article having a three-dimensional shape.

### Comparative Example 2-1

A mixed liquid was produced in the same manner as in Example 1, except that PEG-PPG Oligomer 1 was not used. Resin molded articles of various shapes were produced in the same manner as in Example 2-1, using the mixed liquid thus obtained.

### Examples 2-2 and 2-3 and Reference Example

Mixed liquids were produced at the mixing ratios indicated in Table 4. Resin molded articles of various shapes were produced in the same manner as in Example 2-1, using the mixed liquid thus obtained.

### 4. Evaluation: Storage Modulus

A short strip-shaped specimen having a width of 5 mm and a length of 30 mm was cut out from a film-shaped molded article. Using this specimen, the storage modulus at 25° C. was measured with a dynamic viscoelasticity analyzer (RSA-G2) manufactured by TA Instruments, Inc. The measurement conditions were as follows.
Distance between chucks: 20 mm
Measurement frequency: 10 Hz
Rate of temperature increase: 5° C./min

Shape Memory Properties

A film-shaped molded article was folded two times, and while in that state, the folds were pressed with a glass tube. It was confirmed that the folded shape substantially did not return to the original shape. A spiral-shaped molded article was extended and deformed into a rod shape. A cup-shaped molded article was deformed by interposing the molded article between two sheets of glass plates and pressing the molded article in the height direction. A case in which the molded article having various shapes retained the shape after deformation was considered as “good”, and a case in which the shape was not retained was considered as “defective”.

Thereafter, the deformed molded article was immersed in water at 70° C., and it was confirmed by visual inspection that the molded article restored the initial shape within 10 seconds from immediately after immersion. A case in which the molded article restored the initial shape was considered as “good”, and a case in which the molded article did not restore the initial shape was considered as “defective”.

Folding Resistance

In regard to the film-shaped molded articles of Examples, folded portions were restored to the original state, and then those portions were observed by visual inspection and with an optical microscope (100 times). Compared to the state before being folded, a case in which there was no change in the external appearance was considered as “good”, and a case in which abnormalities such as whitening and voids occurred was considered as “defective”.

Measurement of strength at break and elongation at break A polyethylene terephthalate (PET) film was spread in a stainless steel metal mold having a dimension of length×width×depth of 46 min×10 mm×1 mm. A resin composition was poured thereinto, and the metal mold was covered with a transparent sheet made of PET on the resin composition. The resin composition was irradiated with ultraviolet radiation at a dose of 2,000 mJ/cm² from above the transparent sheet at room temperature (25° C.; hereinafter, the same), and thus a resin film was obtained.

A short strip-shaped specimen (width: 8 mm, thickness: 1 mm) was cut out from the resin film thus obtained. This specimen was used to measure the strength at break and the elongation at break using a STROGRAPH T (manufactured by Toyo Seiki Seisakusho Co., Ltd.) under the conditions of room temperature, a distance between chucks of 30 mm, and a tensile rate of 10.0 mm/min.

TABLE 4

| | | Example | | Example | | Example | | Comparative | | Reference | |
|---|---|---|---|---|---|---|---|---|---|---|---|
| | | 2-1 | | 2-2 | | 2-3 | | Example 2-1 | | Example | |
| First polymer | BACH | 69.5 | μmol | 69.5 | μmol | 69.5 | μmol | 69.5 | μmol | 69.5 | μmol |
| | 2-Ethylhexyl | 3.00 | mmol | 2.00 | mmol | 3.00 | mmol | 3.00 | mmol | — | |
| | acrylate | | | | | | | | | | |
| | Lauryl methacrylate | — | | — | | — | | — | | 5.00 | mmol |
| | Acrylonitrile | 3.00 | mmol | 4.00 | mmol | 3.00 | mmol | 3.00 | mmol | 1.00 | mmol |

| | | | | | | | | | |
|---|---|---|---|---|---|---|---|---|---|
| Second polymer | Oligomer 1 | 2.88 | μmol | 2.88 | μmol | — | — | 2.88 | μmol |

| | | | | | | |
|---|---|---|---|---|---|---|
| PEG-PPG | Oligomer 2 | — | 2.88 | μmol | — | — |
| oligomer | | | | | | |

| | | | | | | | | | | |
|---|---|---|---|---|---|---|---|---|---|---|
| Storage modulus | 1.4 | MPa | 10 | MPa | 4.0 | MPa | 1.2 | MPa | 0.1 | MPa |

| | | | | | | |
|---|---|---|---|---|---|---|
| Film-shaped | Shape retainability | Good | Good | Good | Good | Good |
| molded article | Shape restorability | Good | Good | Good | Defective | Defective |
| Spiral-shaped | Shape retainability | Good | Good | Good | Good | Defective |
| molded article | Shape restorabiiity | Good | Good | Good | Defective | Defective |
| Cup-shaped | Shape retainability | Good | Good | Good | Good | Defective |
| molded article | Shape restorability | Good | Good | Good | Good | Defective |

| Folding resistance | Good | | Good | | Good | | Defective | | Defective | |
|---|---|---|---|---|---|---|---|---|---|---|
| Strength at break | 20 | MPa | 25 | MPa | 20 | MPa | 20 | MPa | 1 | MPa |

| | | | | | |
|---|---|---|---|---|---|
| Elongation at break | 250% | 210% | 180% | 70% | 170% |

The resin molded articles of various Examples had excellent folding resistance and exhibited high elongation percentages. Furthermore, the resin molded articles of various Examples had satisfactory shape memory properties. From these results, it was confirmed that according to an aspect of the present invention, a resin molded article having shape memory properties, which exhibited excellent heating-induced shape restorability, is obtained.

### REFERENCE SIGNS LIST

1: Resin molded article

1. A curable resin composition, comprising:
radical polymerizable monomers including a monofunctional radical polymerizable monomer;
a linear or branched polymer containing a polyoxyalkylene chain; and
a radical polymerization initiator.

2. The curable resin composition according to claim 1, wherein the polyoxyalkylene chain is a polyoxyethylene chain, a polyoxypropylene chain, or a combination thereof.

3. The curable resin composition according to claim 1, wherein the polymer is a reaction product between a bifunctional alcohol having the polyoxyalkylene chain and a bifunctional isocyanate.

4. The curable resin composition according to claim 3, wherein the number average molecular weight of the bifunctional alcohol is 500 to 20,000.

5. The curable resin composition according to claim 1, wherein the proportion of the polyoxyalkylene chain in the polymer is 20% to 60% by mass based on the mass of the polymer.

6. The curable resin composition according to claim 1, wherein the number average molecular weight of the polymer is 3,000 to 150,000.

7. The curable resin composition according to claim 1, wherein the polymer contains two or more polyoxyalkylene chains and linking groups that connect those polyoxyalkylene chains, and the linking group has a cyclic group.

8. The curable resin composition according to claim 1, wherein the content of the polymer is 1% to 20% by mass based on the mass of the curable resin composition.

9. The curable resin composition according to claim 1, wherein the monofunctional radical polymerizable monomer includes an alkyl (meth)acrylate having an alkyl group with 1 to 16 carbon atoms which may have a substituent.

10. The curable resin composition according to claim 1, wherein the monofunctional radical polymerizable monomer includes acrylonitrile.

11. The curable resin composition according to claim 1, wherein the radical polymerization initiator is a photoradical polymerization initiator.

12. A resin molded article, comprising:
a first polymer containing a radical polymerizable compound represented by Formula (I): 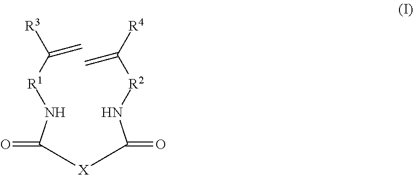
wherein X, R¹, and R² each independently represent a divalent organic group; and R³ and R⁴ each independently represent a hydrogen atom or a methyl group, and a monofunctional radical polymerizable monomer as monomer units; and
a linear or branched second polymer,
wherein the resin molded article has a storage modulus of 0.5 MPa or higher at 25° C.

13. A resin molded article, comprising:
a first polymer containing a radical polymerizable compound represented by Formula (I): 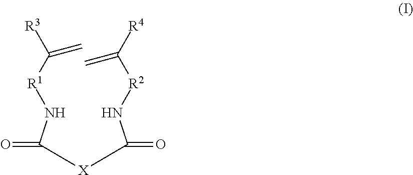
wherein X, R¹, and R² each independently represent a divalent organic group; and R³ and R⁴ each independently represent a hydrogen atom or a methyl group, and a monofunctional radical polymerizable monomer as monomer units; and
a linear or branched second polymer,
wherein the resin molded article has shape memory properties.

14. The resin molded article according to claim 12, wherein the second polymer is a polymer containing a polyoxyalkylene chain.

15. The resin molded article according to claim 12, wherein the monofunctional radical polymerizable monomer includes an alkyl (meth)acrylate having an alkyl group having 1 to 16 carbon atoms which may have a substituent.

16. The resin molded article according to claim 12, wherein the monofunctional radical polymerizable monomer includes acrylonitrile.

17. The resin molded article according to claim 12, wherein X in Formula (I) represents a group represented by the following Formula (10):
*—Z¹—(CH₂)ᵢ—Y—(CH₂)ⱼ—Z²—* (10)
wherein Y represents a cyclic group which may have a substituent; Z¹ and Z² each independently represent a functional group containing atoms selected from a carbon atom, an oxygen atom, a nitrogen atom, and a sulfur atom; i and j each independently represent an integer from 0 to 2; and the symbol * represents a linking point.

18. The resin molded article according to claim 12, wherein the weight average molecular weight of the second polymer is 5,000 or more.

19. A composition for molding, comprising:
radical polymerizable monomers including a radical polymerizable compound represented by Formula (I): 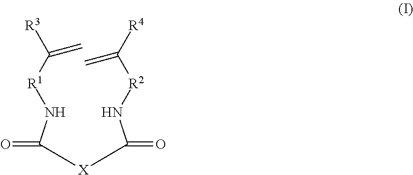
wherein X, R¹, and R² each independently represent a divalent organic group; and R³ and R⁴ each independently represent a hydrogen atom or a methyl group, and a monofunctional radical polymerizable monomer; and
a linear or branched second polymer,
wherein when the radical polymerizable monomers are polymerized in the presence of the second polymer so as to form a first polymer, the composition for molding forms a resin molded article having a storage modulus of 0.5 MPa or higher at 25° C.

20. A composition for molding, comprising:
radical polymerizable monomers including a radical polymerizable compound represented by Formula (I): 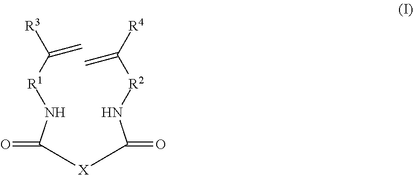
wherein X, R¹, and R² each independently represent a divalent organic group; and R³ and R⁴ each independently represent a hydrogen atom or a methyl group, and a monofunctional radical polymerizable monomer; and
a linear or branched second polymer,
wherein when the radical polymerizable monomers are polymerized in the presence of the second polymer so as to form a first polymer, the composition for molding forms a resin molded article having shape memory properties.

21. A method for producing a resin molded article containing a first polymer and a linear or branched second polymer,
the method comprising a step of producing the first polymer by polymerization of radical polymerizable monomers in a composition for molding, the composition for molding including the radical polymerizable monomers including a radical polymerizable compound represented by Formula (I): 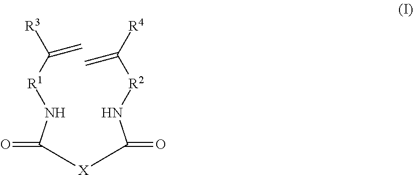
wherein X, R¹, and R² each independently represent a divalent organic group; and R³ and R⁴ each independently represent a hydrogen atom or a methyl group, and a monofunctional radical polymerizable monomer; and the second polymer.
